(19) United States
(12) Patent Application Publication
(10) Pub. No.: US 2018/0123988 A1
(43) Pub. Date: May 3, 2018

(54) APPARATUS AND METHOD FOR EMAIL-BASED PROJECT MANAGEMENT

(71) Applicant: PracticeIQ Inc., Presidio, CA (US)

(72) Inventors: Stuart McLeod, Mill Valley, CA (US); Ian Vacin, Fremont, CA (US); Tim Donohouse, San Francisco, CA (US); John Freeman, Mill Valley, CA (US)

(21) Appl. No.: 15/336,230

(22) Filed: Oct. 27, 2016

(51) Int. Cl. H04L 12/58; H04L 29/08

(52) U.S. Cl. CPC H04L 51/046; H04L 67/26

(57) ABSTRACT

An apparatus has a processor and a memory connected to the processor. The memory stores instructions executed by the processor to host an email service module operative to exchange email over a public network. A work management module is executed within a private network. The work management module includes instructions executed by the processor to pull email instances from the email service module, push processed email instances to the email service module, and associate email instances with project management tasks. Each project management task has project parameters accessible by users of the private network.

### FIELD OF THE INVENTION

This invention relates generally to email communications in computer networks. More particularly, this invention relates to techniques for email-based project management.

### BACKGROUND OF THE INVENTION

Service-based professionals communicate and collaborate with their co-workers and clients (customers) predominantly through email. Those emails include updates, changes in service requests, details for projects, and other key information that directly impacts the work being done within a firm providing a service. That work is generally completed using multiple people (resources). Traditionally, email is separate from the systems used to manage and complete work. This problem is further complicated in a multi-person firm since each email account is isolated and unconnected not only from the work management system, but also from the inboxes of colleagues. Thus it is difficult to get a true sense of the status of a project. Accordingly, there is a need for improved techniques for email-based project management.

### SUMMARY OF THE INVENTION

An apparatus has a processor and a memory connected to the processor. The memory stores instructions executed by the processor to host an email service module operative to exchange email over a public network. A work management module is executed within a private network. The work management module includes instructions executed by the processor to pull email instances from the email service module, push processed email instances to the email service module, and associate email instances with project management tasks. Each project management task has project parameters accessible by users of the private network.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates executable module interactions associated with an embodiment of the invention.

FIG. 3 illustrates work management module operations performed in accordance with an embodiment of the invention.

FIGS. 4-20 illustrate graphical user interfaces utilized in accordance with embodiments of the invention.

Like reference numerals refer to corresponding parts throughout the several views of the drawings.

### DETAILED DESCRIPTION OF THE INVENTION

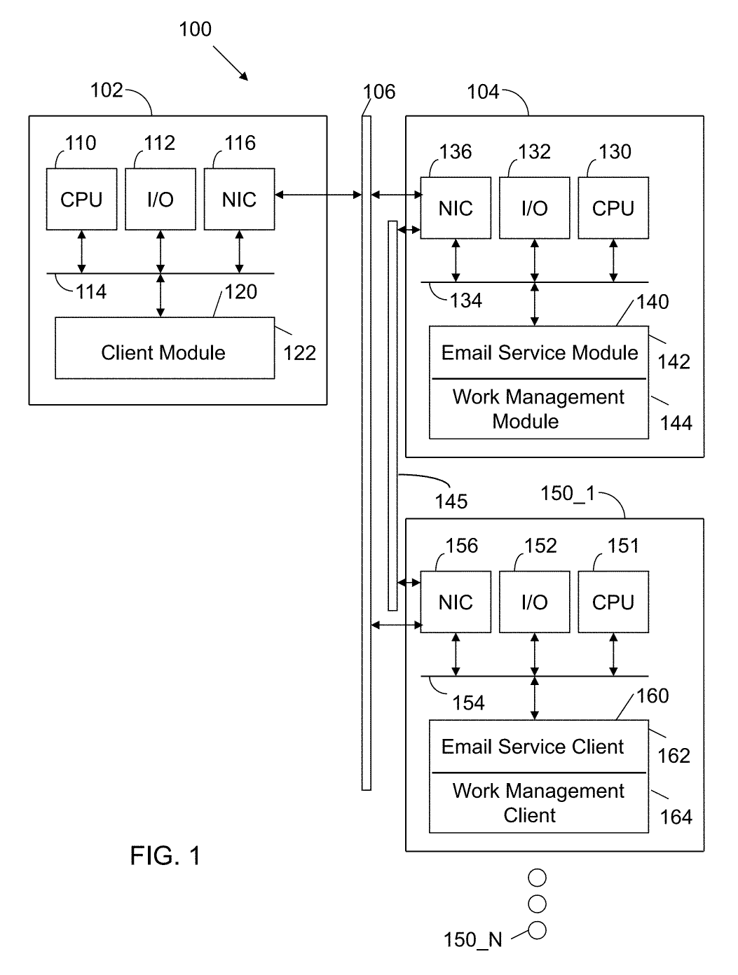

FIG. 1 illustrates a system 100 configured in accordance with an embodiment of the invention. The system 100 includes a client device 102 and a server 104 connected via a network 106, which may be any combination of wired and wireless networks. Client device 102 includes standard components, such as a central processing unit 110 and input/output devices 112 connected via a bus 114. A network interface circuit 116 is also connected to the bus 114 to provide connectivity to network 106. A memory 120 is also connected to the bus 114. The memory 120 stores a client module 122 with instructions executed by the central processing unit 110. The client module 122 may be a browser or an application that is used to access server 104. The client module 122 may be used to submit requests for services that are coordinated by server 104. The client device 102 may be a computer, tablet, smartphone, and the like.

Server 104 also includes standard components, such as a central processing unit 130, input/output devices 132, a bus 134 and a network interface circuit 136. A memory 140 is connected to the bus 134. The memory 140 stores an email service module 142. The email service module 142 includes instructions executed by central processing unit 130 to implement standard email hosting services (e.g., email hosting services provided by Office365® from Microsoft® or Gmail® from Google®). The email service module 142 may reside on another machine connected to network 106.

The memory 140 also stores a work management module 144 with instructions executed by the central processing unit 130. The work management module 144 includes instructions to pull email instances from the email service module 142. It also pushes processed email instances to the email service module 142. The work management module 144 associates email instances with project management tasks. Each project management task has project parameters accessible by users within a private network.

FIG. 1 illustrates server 104 also being connected to a private network 145. Client devices 150_1 through 150_N are also connected to the private network 145. By way of example, the private network 145 may be a network within a firm providing a service. Server 104 coordinates activity performed by workers that utilize the client devices 150_1 through 150_N. Each client device (e.g., client 150_1) includes standard components, such as a central processing unit 151, input/output devices 152, a bus 154 and a network interface circuit 156. A memory 160 is connected bus 154. The memory 160 stores an email service client 162 and a work management client 164. The email service client 162 is a client instance associated with the email service module 142. Similarly, the work management client 164 is a client instance associated with the work management module 144.

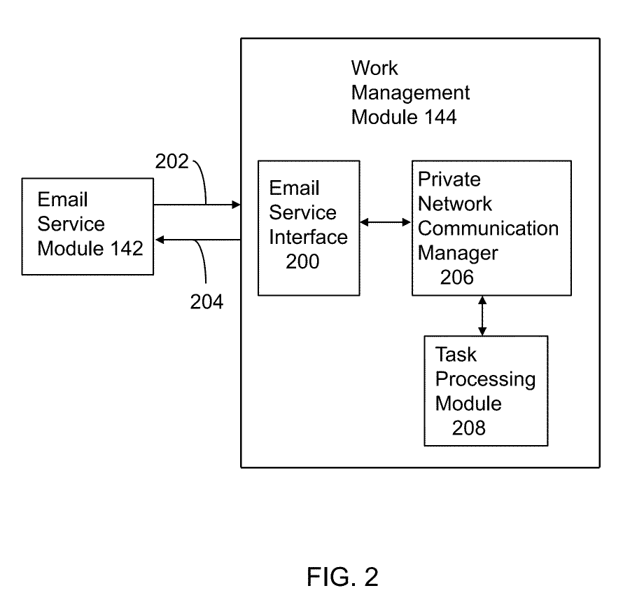

FIG. 2 illustrates interactions between the email service module 142 and the work management module 144. The work management module 144 includes an email service interface 200. The email service interface 200 is configured to pull email instances from the email service module 142, as indicated with arrow 202. The email service interface 200 is also configured to push email instances to the email service module 142, as indicated with arrow 204.

The work management module 144 also includes a private network communication manager 206. The private network communication manager 206 is operative between the email service interface 200 and a task processing module 208. The private network communication manager 206 collects emails from the email service interface 200 and assigns them to a workflow managed by the task processing module 208. The private network communication manager 206 also sends emails generated within the work management module 144 to the email service interface 200 for processing by the email service module 142. Thus, the work management module 144 operates as a parallel email system in a project management context.

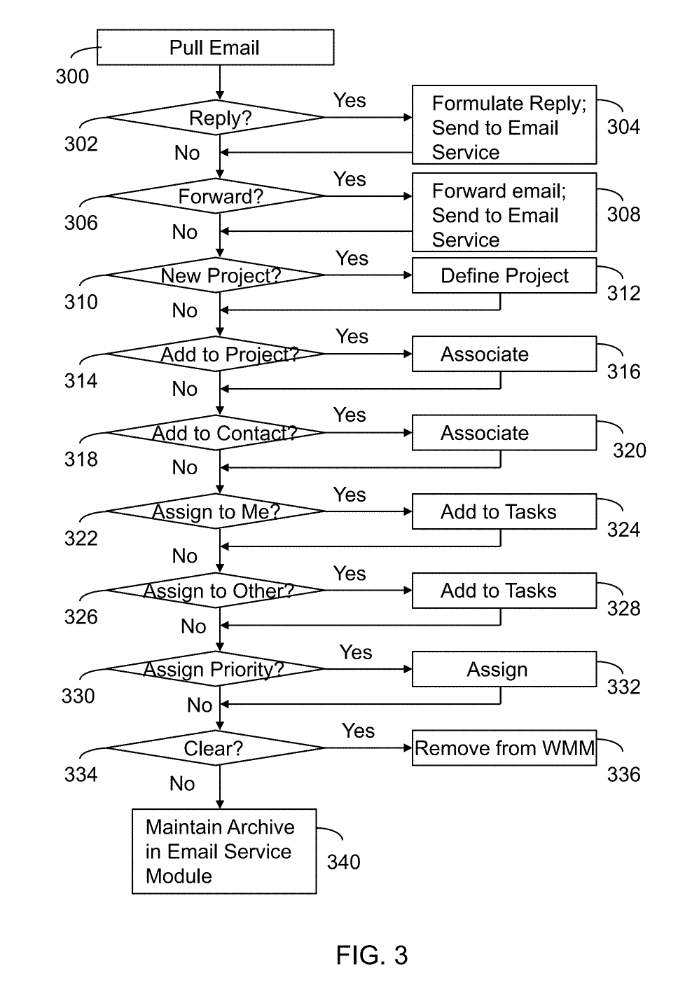

FIG. 3 illustrates processing operations associated with an embodiment of the work management module 144. An email is pulled 300 (e.g., email service interface 200 pulls an email from the email service module 142, as indicated with arrow 202). The user has an option to reply 302 to the email. If the user replies (302—Yes) a reply is formulated and is sent to the email service 304. That is, a reply is formulated in the work management module 144. That reply is then sent to the email service module 142. Thus, the email service module 142 is effectively hosting and processing emails created in the work management module 144. Similarly, a user has an option to forward an email 306. If that option is selected (306—Yes), the email is forwarded by the work management module 144 to the email service module 142. The foregoing processing illustrates the parallel email system operative in the work management module 144, but which also interfaces with the email service module 142.

In addition to a parallel email system, the work management module 144 provides project management features. Thus, as shown in FIG. 3, a pulled email may be associated with a new project 310. If so (310—Yes), the project is defined 312. Examples of this process are provided below. Alternately, the email may be added to an existing project 314. If so (314—Yes), the email is associated with a project 316. Examples of this operation are provided below.

The email may also be added to a contact 318. For example, the contact may be an individual within a service firm. If the contact is added (318—Yes), the contact is associated with the email and thereafter the email is visible to the contact, even though the contact was not an original recipient of the email. For example, the contact and associated email may be placed on a time line viewable by people in the firm with rights to see the contact and details.

The email may be assigned as a task to the recipient 322. If so (322—Yes), it is added to the tasks associated with the recipient 324. Alternately, the email may be assigned as a task for another 326 individual in the firm. If so (326—Yes), it is added as a task for the other individual 328. Examples of these operations are provided below.

The email may also be assigned a priority 330. If a priority is requested (330—Yes), a priority value is assigned 332. The work management module 144 may also support a clear operation 334. If a task is to be cleared (334—Yes) the task is removed 336 from the work management module 144. For example, all descriptions, timelines and emails associated with the task may be deleted. Nevertheless, in this case, emails associated with the task are maintained in the archive of the email service module 340.

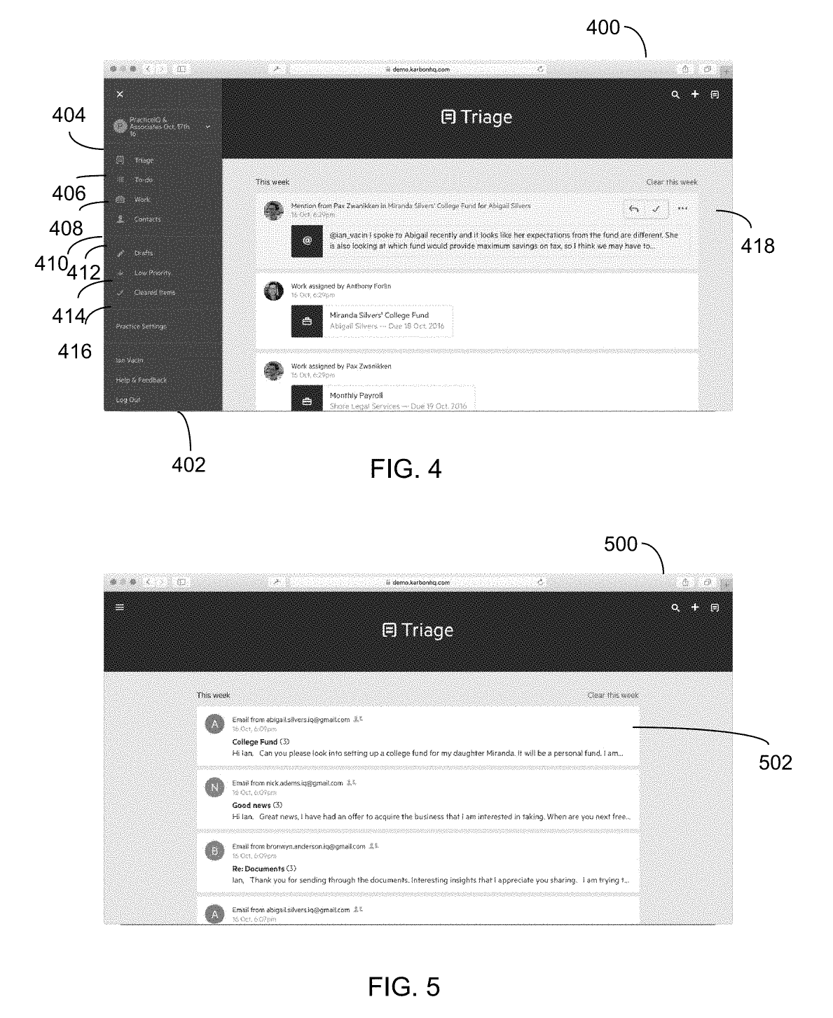

The foregoing operations are more fully appreciated with reference to specific examples. FIG. 4 illustrates an interface 400 with an expanded menu bar 402. The menu bar 402 includes a triage mode 404. This mode shows emails from external people (e.g., from over the public network 106), conversations from internal people (e.g., over private network 145) and notifications from underlying triggers, alerts and system activities associated with work management. The menu bar may also invoke a To-Do list 406 and a work list 408. Contacts 410 may also be accessed. Draft emails may be accessed through button 412. Priority may be assigned through button 414. For example, priority may be assigned to an email. For example, if an email, email thread or email address is determined to be low priority, those emails are only visible in a low priority area, not in Triage mode, which is reserved for high priority emails and communications.

Cleared items may be accessed through button 416. Block 418 shows communications in triage mode.

FIG. 5 illustrates an interface 500 operative as an email inbox with a list 502 of emails. The email mode of the work management module 144 does not replace the email service module 142. Rather, it sits on top of an existing email client pulling the email in to allow one to view, edit, and action each and every email. Each email is kept in sync with the underlying email service module 142. If, for instance, an email is sent from the work management module 144, it is sent through the email service module 142 and thus it appears in the sent email folder of the email service module 142. If an email is read in the work management module 144, it is marked as read in both the work management module 144 and the email service module 144.

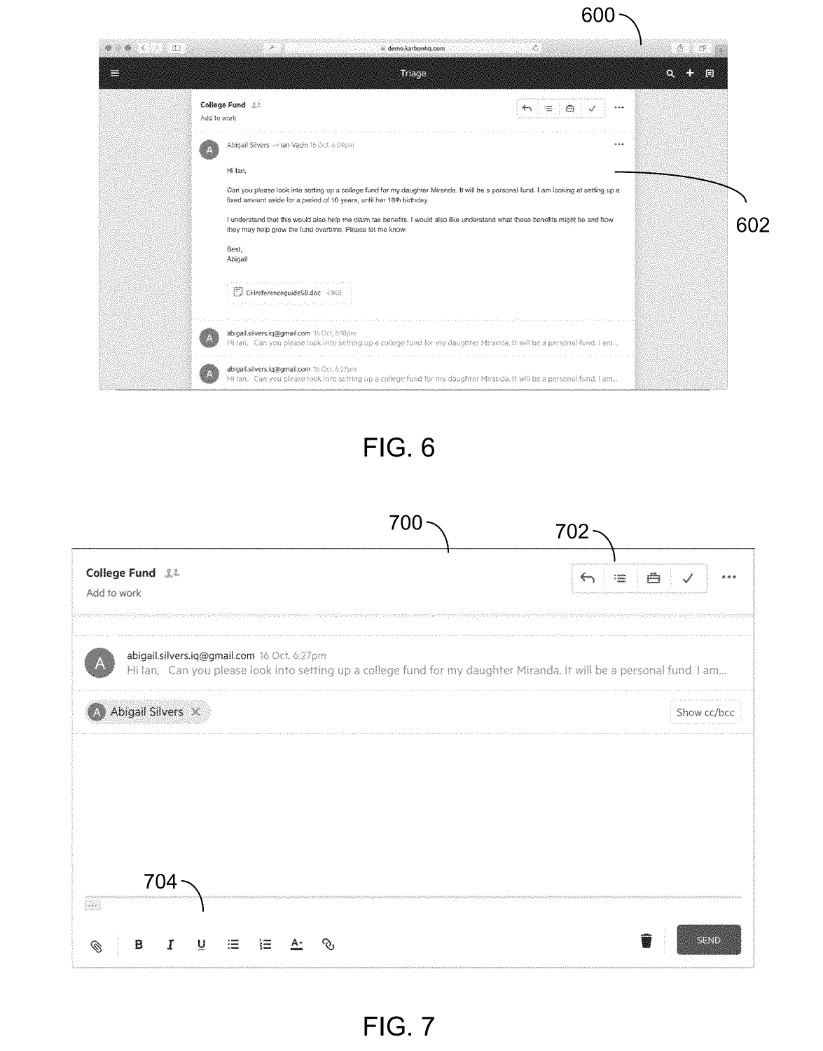

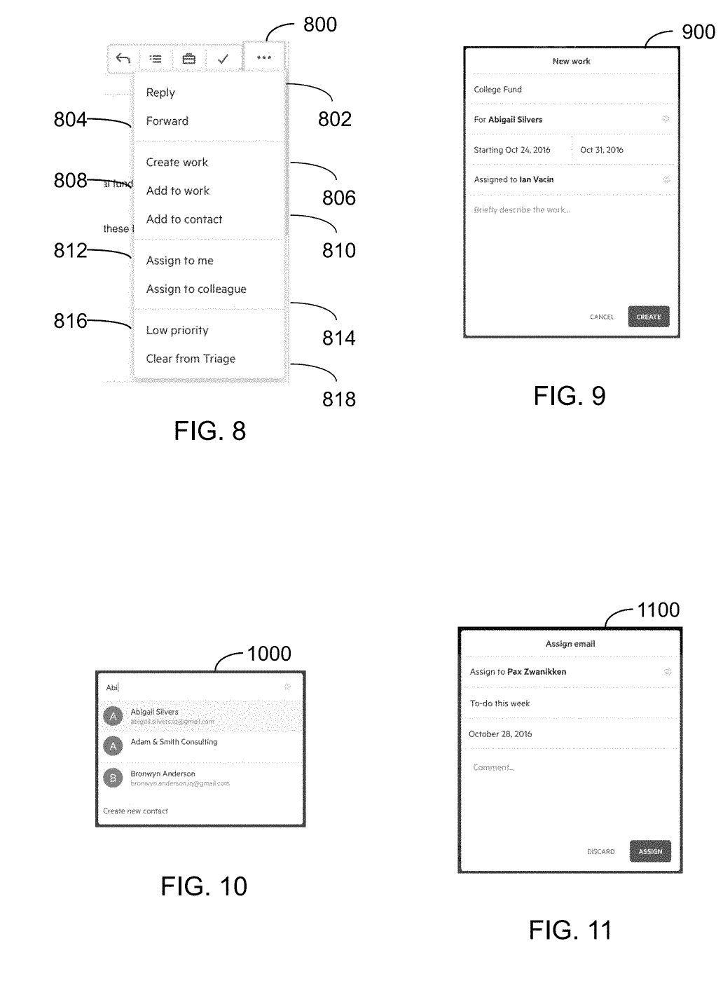

FIG. 6 illustrates an interface 600 displaying a selected email 602. The work management module 144 has a full email viewer and editor. This allows the user to read and respond directly to email within the work management module 144 without having to return to the email service module 142. Interface 700 of FIG. 7 includes standard email routing prompts 702 and editing prompts 704. Activation of prompt 702 results in the interface 800 of FIG. 8.

Interface 800 shows different processing options for an email. Activation of the reply tile 802 sends an email back to a client. The reply email is formulated in the work management module 144, but is sent through the email service module 142. Activation of the forward tile 804 results in the passing along of details to someone who needs to be aware of the email communication. This is again an email sent through the email service module 142. The create work tile 806 initiates a new project. The creator of the project can add the Project Owner, Start Date, End Date, and any additional notes. Interface 900 of FIG. 9 is an example of prompts available for the creator of a project.

The add to work tile 808 specifies that the email communication belongs to an existing project and needs to be flagged as such so that it can be reviewed in the context of the project already created. When an email is associated to a project, it is always automatically associated to the underlying contact of that project.

An add to contact tile 810 is used when the communication should be associated and placed on the communication timeline for a specific contact. FIG. 10 illustrates a contact screen 1000 that may be used in accordance with an embodiment of the invention. All emails in a person's Triage mode are private by default until an associated contact is added to the work management module 144 or the email is associated with a project. In either case, the email is automatically assigned, made visible within the firm and visible in the project and/or contact timelines.

If a contact exists, the email is associated with the contact. If the contact does not exist, one can create a contact and/or place an email in a project, which then allows the email to be viewed by all in the firm from the project or contact timeline. Any individual email and thread can be marked private at any time by the user. In the case of assigning an email to a new piece of work that does not have a contact, a new contact is created. Contact creation involves validating a name and an email address.

An assign to me tile 812 is used when the email or related activity cannot be completed at the moment. The email is actioned by assigning it to oneself to create a full descriptive, contextual to-do that includes its due date, when to do the to-do, and any related notes to remember why the to-do was created. FIG. 11 illustrates an assign interface 1100 that may be used in accordance with an embodiment of the invention. The same interface may be supplied in response to activation of the assign to colleague tile 814 of FIG. 8. The colleague receives a notification in their Triage mode that they have a new to-do assigned to them.

The interface 800 may also be used to assign a priority using priority tile 816. For example, the priority tile 816 may be used to assign a low priority or spam status so that it is placed in a separate Triage area called Low Priority for review and processing.

Finally, interface 800 includes a clear from Triage tile 818. Once an email is actioned, it should be cleared from Triage which effectively archives it in the email service module 142 and removes it from view in the work management module 144. In one embodiment, the email is still viewable on the timeline for a project, but is not viewable in the Triage mode.

By taking an action on an email like creating work, adding to work, or adding to a contact, the email communication is filed into the timeline of the associated contact and/or project making it visible to others. This ensures its content is preserved. It also places the communication in the right context for reviewing later, such as when a client calls asking a specific question (you can see it in the project reference or by looking at the contact's details). Even better, not only is that single communication associated there, so is every future follow-up email to that specific email subject line (email thread).

When assigning an email to oneself or to a colleague, that email becomes a To-Do that provides the owner the context by which it was created (contact and project if available), but also when it was requested to be completed. That email is thus actioned into a To-Do and can be prioritized and completed later when other tasks are dealt with.

The foregoing discussion is directed to email. The work management module 144 also supports internal team communications on work, contacts and the like that can be in a mode called Notes. Notes are internal to the firm and cannot be sent out of the firm to clients. They are similar in regards to emails except for the inability to send externally out of the firm and that they do not live in ones email—only in the work management module 144. When a note is created in a project or contact and it does not flag someone, it is just placed in the associated timeline. If however, the note is created and a team member is flagged, then the team member receives a notification in their Triage mode on what the note is while also receiving a To-Do to ensure the note is dealt with appropriately. If a task is created and assigned to an individual, a To-Do is created for the individual. If a note is created and an individual is flagged, the individual receives the note in Triage mode.

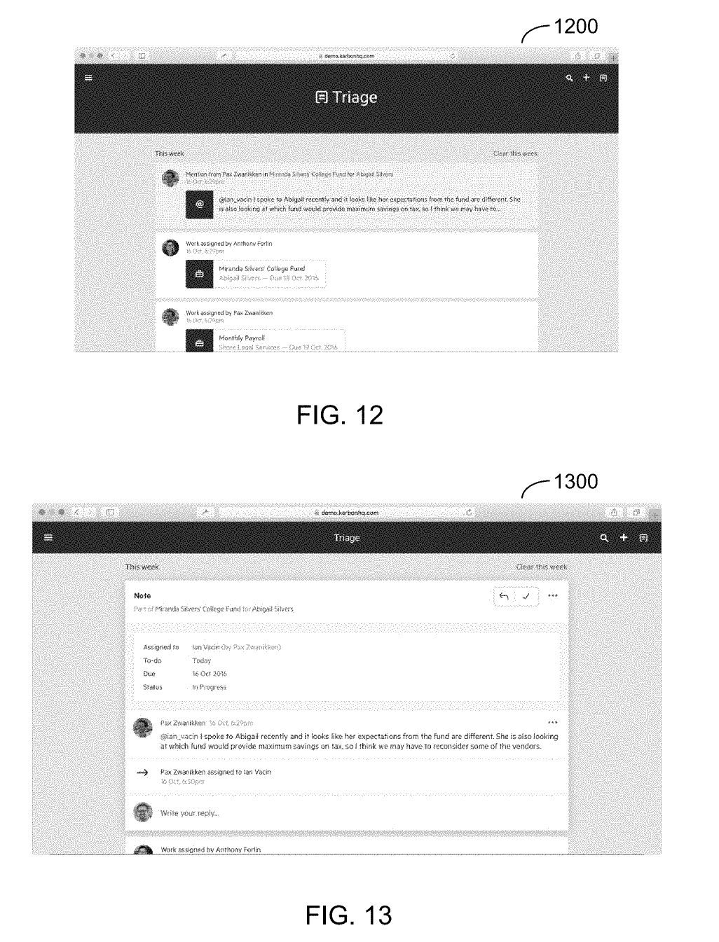

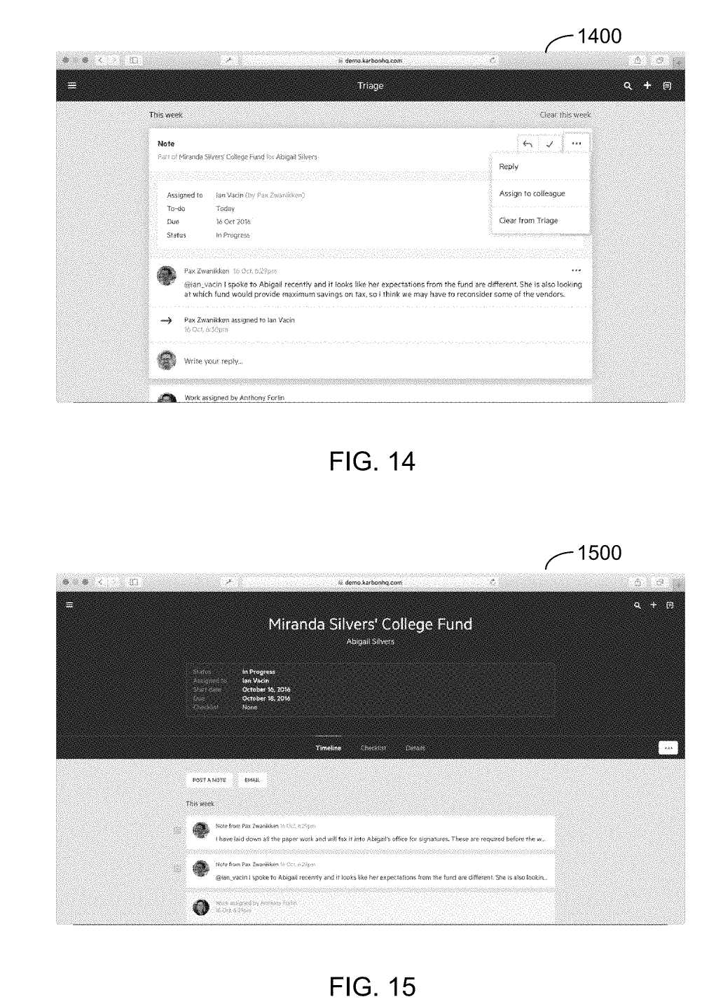

FIG. 12 illustrates an interface 1200 showing internal notifications and notes. Similar to email, notes have a full editor to create them, as shown in interface 1300 of FIG. 13. When flagged to someone else, a note may have a due date, status and an associated To-Do date. Like an email, a note can be actioned, but in a more limited fashion. It can be replied to, assigned to a colleague or just cleared if not relevant or completed. FIG. 14 illustrates an interface 1400 to support these operations.

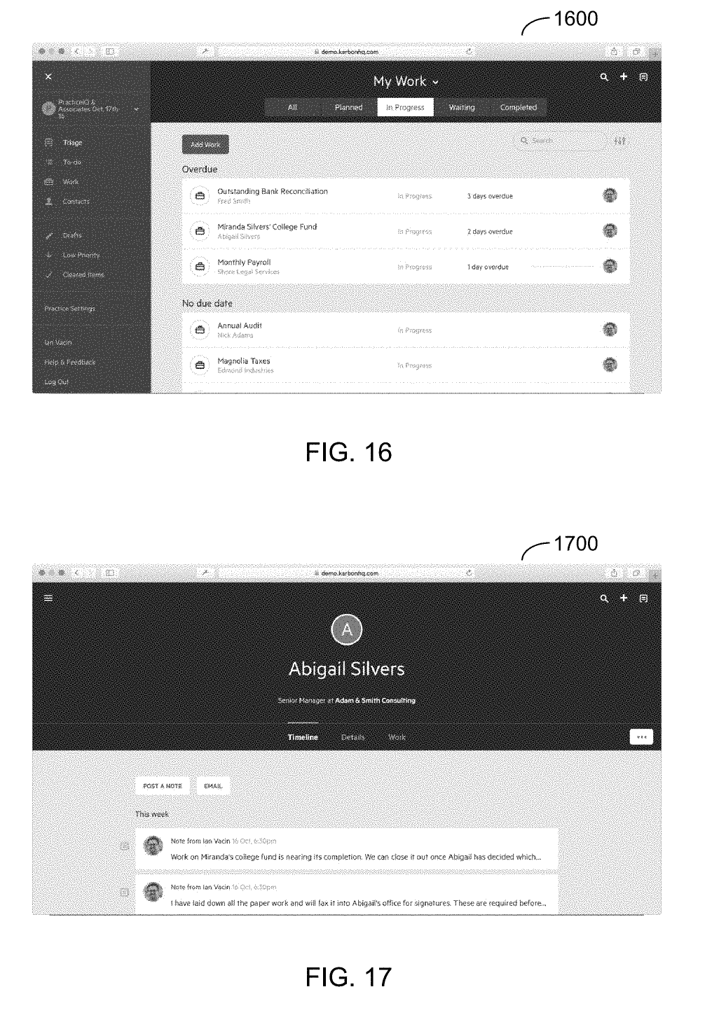

The foregoing functionality is supplied in an effort to ensure that projects are kept up-to-date with as little effort as possible across all the work within a firm. Those projects may be displayed in a list for easy evaluation and consumption, such as shown in interface 1500 of FIG. 15. FIG. 16 illustrates an interface 1600 with a project overview and time line. From the work overview screen or from clicking directly in the assigned work name in the actual email or note, one can review the project in its full detail. In a given project, there are three categories of information stored: Timeline, Checklists, and Details. As it relates to email and Triage, the first section called Timeline is where the Triaged communications (external emails) and internal notes are place in chronological order to provide the firm employee a quick recap on what has been said over the life of the project with a particular client.

Similarly, those same communications are automatically placed in the contact (or client firm) record as they are created and processed as well. While a project requires a selection (e.g., Add to Work) to occur in Triage, a contact does not as long as the contact record is created in the system. This ensures no effort by the user is needed and also ensures the full history is always available. Interface 1700 of FIG. 17 shows a contact overview with a time line.

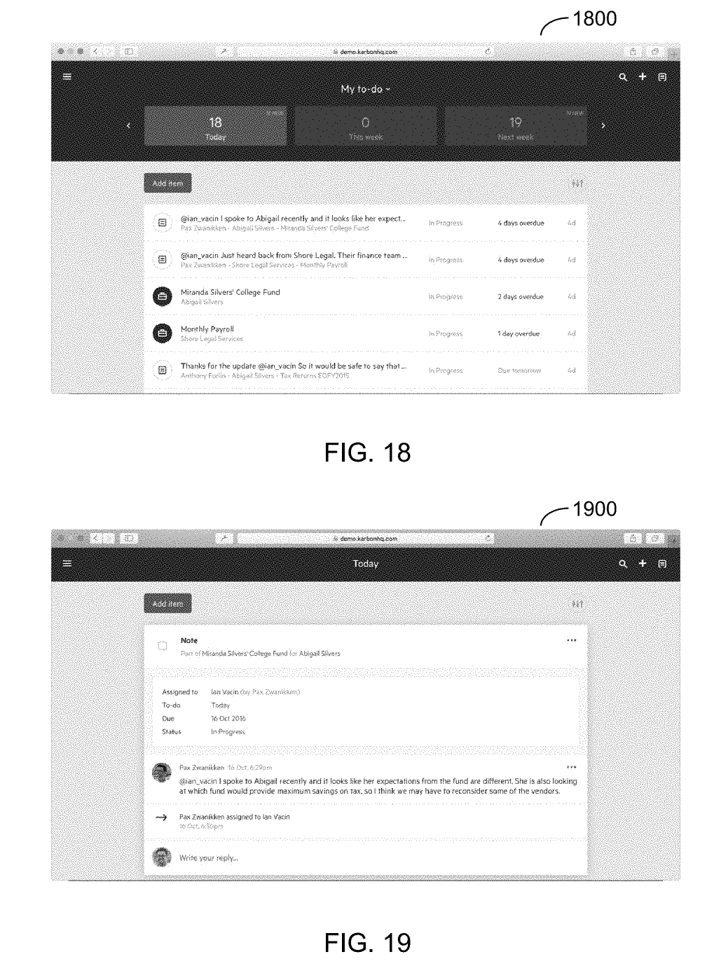

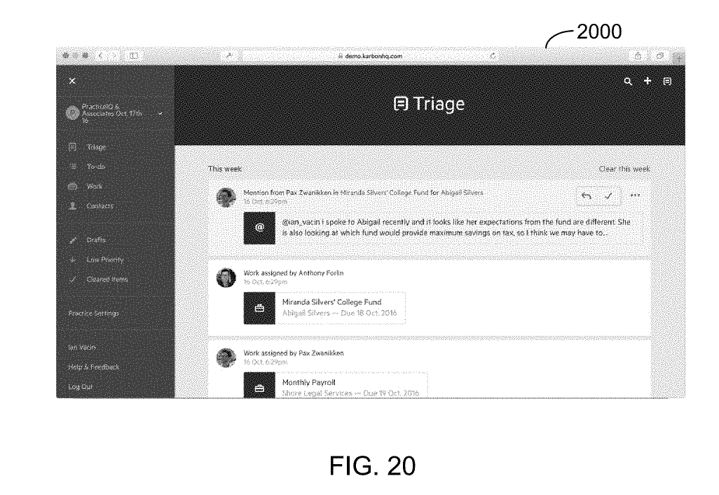

While an email can be added to a project or client, it can also be assigned to oneself or to a colleague. The purpose of this is to clear the communication out of one's inbox and address it when time is available to complete. Thus, when assigning to someone else, one can add the relative to-do date and the actual due date as well as a note to help direct the person or oneself on what to do later. The system leverages the information from the communication to create a well formed To-Do amongst the other To-Dos that are available. Email and note derived To-Dos are identified using the Note icon next to the content. FIG. 18 illustrates an interface 1800 with a To-Do overview and associated time line. Selection of an item in interface 1800 may result in To-Do details, such as shown in interface 1900 of FIG. 19. Interface 2000 of FIG. 20 is another example of information that may be displayed in Triage mode.

The disclosed system is unique in that it marries the communications (both internally and externally) for a team into one place which allows for the communications to be actioned to ensure a fully read and processed inbox while keeping work up-to-date and visible across a multi-person firm. This increases efficiency, accuracy, and transparency in regards to managing clients and their related projects.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a processor; and
a memory connected to the processor, the memory storing instructions executed by the processor to:
host an email service module operative to exchange email over a public network,
execute a work management module within a private network, the work management module including instructions executed by the processor to:
pull email instances from the email service module,
push processed email instances to the email service module, and
associate email instances with project management tasks, wherein each project management task has project parameters accessible by users of the private network.

2. The apparatus of claim 1 wherein the processed email instances include a reply email created within the work management module.

3. The apparatus of claim 1 wherein the processed email instances include a forwarded email created within the work management module.

4. The apparatus of claim 1 wherein the project management tasks include a new project defined within the work management module by an email recipient.

5. The apparatus of claim 1 wherein the project parameters include project participants that are users of the private network.

6. The apparatus of claim 1 wherein the project parameters include contacts that are users of the private network.

7. The apparatus of claim 1 wherein the project parameters include an assigned task.

8. The apparatus of claim 7 wherein the assigned task is assigned to an email recipient by the email recipient.

9. The apparatus of claim 7 wherein the assigned task is assigned to a colleague by an email recipient.

10. The apparatus of claim 1 wherein the project parameters include a project priority parameter.

11. The apparatus of claim 1 wherein the work management module includes instructions executed by the processor to form a task list for a user of the private network.

12. The apparatus of claim 1 wherein the work management module includes instructions executed by the processor to form a timeline for a project management task.

13. The apparatus of claim 1 wherein the work management module includes instructions executed by the processor to remove a project management task from the private network, such that the private network eliminates email instances associated with the project management task, while the email service module archives selected email instances associated with the project management task.
